(19) United States
(12) Patent Application Publication
(10) Pub. No.: US 2013/0330260 A1
(43) Pub. Date: Dec. 12, 2013

(54) ALUMINA-BASED SULFUR RECOVERY CATALYST AND PREPARATION METHOD FOR THE SAME

(71) Applicants: Aihua LIU, Zibo City (CN); Zhaoshun Sheng, Zibo City (CN); Jianli Liu, Zibo City (CN); Jianhua Wang, Zibo City (CN); Dehua Zhu, Zibo City (CN); Zengrang Liu, Zibo City (CN); Yingjie Liang, Zibo City (CN)

(72) Inventors: Aihua LIU, Zibo City (CN); Zhaoshun Sheng, Zibo City (CN); Jianli Liu, Zibo City (CN); Jianhua Wang, Zibo City (CN); Dehua Zhu, Zibo City (CN); Zengrang Liu, Zibo City (CN); Yingjie Liang, Zibo City (CN)

(73) Assignee: CHINA PETROLEUM & CHEMICAL CORPORATION, Beijing (CN)

(21) Appl. No.: 13/914,849

(22) Filed: Jun. 11, 2013

(30) Foreign Application Priority Data
Jun. 12, 2012 (CN) 201210192484.5

(51) Int. Cl. B01J 31/26; B01D 53/52

(52) U.S. Cl. CPC B01J 31/26; B01D 53/523
USPC 423/222; 502/355; 502/170; 502/8

(57) ABSTRACT

Provided is an alumina-based sulfur recovery catalyst as well as its preparation method, characterized in that the catalyst has a specific surface area of at least about 350 m²/g, a pore volume of at least about 0.40 ml/g, and the pore volume of pores having a pore diameter of at least 75 nm comprises at least about 30% of the pore volume. The alumina-based catalyst according to present invention is made from flashed calcined alumina, pseudoboehmite and optionally, a binder. The present invention further relates to an use of the alumina-based sulfur recovery catalyst and a method for recovering sulfur by using this catalyst.

The present application claims the priority of China Patent Application No. 201210192484.5 filed on Jun. 12, 2012, which is incorporated herein by reference in its entirety.

### TECHNICAL FILED

The present application generally relates to a high-activity alumina-based sulfur recovery catalyst and a preparation method thereof, particularly a catalyst for converting a mixed gas comprising sulfur-containing compound(s) into element sulfur as well as a preparation method for the same. The catalyst and method of present application are suitable for the recovery of sulfur-containing compound(s) from the desulfurization and decontamination plants of petroleum processing, chemical processing of coal and natural gas.

### BACKGROUNDS

Sulfur-containing compounds from the desulfurization and decontamination plants of petroleum processing, chemical processing of coal and natural gas generally are introduced into a sulfur recovery plant to recover sulfur. The sulfur recovery plant generally includes a sulfur recovery unit and a tail gas treatment unit.

The sulfur recovery unit is mainly used to carry out thermal reactions occurred in a reaction furnace and catalytic reactions occurred in various converters. In the burning oven, the main reaction is Claus reaction and about 60-65% of H₂S is converted into element sulfur after such reactions. In the converters, a low-temperature Claus reaction (as shown below) is carried out between H₂S and SO₂ in the presence of a sulfur recovery catalyst so as to further increase the conversion rate and sulfur yielding of the plant:

2H₂S+SO₂→3/x Sx+2H₂O

The tail gas treatment unit is used to convert the small amount of sulfur-containing compound(s) other than H₂S contained in the Claus tail gas into H₂S through the reactions with H₂ in the presence of a tail gas hydrogenation catalyst. The gas obtained after such reactions is cooled to below 42° C. by a cooling column and introduced into an amine liquid absorption column, wherein H₂S is selectively absorbed by the amine liquid. The absorption solution is introduced into a regeneration column and the H₂S dissolved in methyl diethanolamine is stripped out and the methyl diethanolamine solution is circulated. The stripped H₂S is introduced into the sulfur recovery plant. After the H2S is the tail gas is absorbed by methyl diethanolamine, the purified gas is sent into an incinerator and is released into atmosphere after incinerating.

The main reactions occurred in the Claus tail gas hydrogenation reactor include:

SO₂+3H₂→H₂S+2H₂O

S₈+8H₂→8H₂S

CS₂+4H₂2→H₂S+CH₄

The catalyst used in the sulfur recovery unit and the catalyst used in the tail gas treatment unit are catalysts of different types. Although both catalysts are used in the sulfur recovery plant, they have completely different functions.

The developing of sulfur recovery catalysts goes through the following stages. Initially, natural bauxite catalysts are used in industrial plants and the sulfur recovery rate is from 80% to 85%. The unconverted sulfur compounds are burned and released into atmosphere in the form of SO₂, resulting in a serious environmental pollution. Next, alumina-based sulfur recovery catalysts are developed and the total sulfur recovery rate is improved greatly. Currently, those used in industrial plants are mainly such alumina-based sulfur recovery catalysts. An important example is LS-300 catalyst developed by Research Institute of Qilu Branch, SINOPEC. This catalyst comprises alumina as the main ingredient, has a specific surface area of more than 300 m²/g and has a high Claus activity. A great technical development is achieved from initial bauxite catalysts to LS-300 catalyst.

With the enlargement of the scale of petroleum processing or chemical processing of coal or with the increasing amount of natural gas extracted, it is desirable to make sulfur recovery plants large. A large plant can reduce operation cost and is economically beneficial. Moreover, due to the deterioration of crude oil, higher cleanliness of products and the increasing proportion of high-sulfur crude oil, more and more acid gas is produced. Such large scaled sulfur recovery plants need high activity sulfur recovery catalysts to cooperate with.

The catalytic activity of sulfur recovery catalysts relate closely to the parameter specific surface area. Under given conditions, the bigger the specific surface area, the higher the activity. Thus it is desirable to develop sulfur recovery catalysts having a large specific surface area.

China patent application 200310105748.X discloses a preparation method for sulfur tail gas hydrogenation catalyst.

China patent application 200510042213.1 discloses a Claus tail gas hydrogenation catalyst, wherein the Claus tail gas hydrogenation catalyst is prepared by using silicon-modified pseudoboehmite having a large pore volume and a large specific surface area and flash calcined alumina as main raw materials. It should be noted that the pseudoboehmite used in this application is a silicon-modified pseudoboehmite.

In the art, it is desirable to provide a sulfur recovery catalyst with a high activity.

### Contents of Present Invention

It is an object of present invention to provide a high activity sulfur recovery catalyst and a preparation method for the same, wherein the catalyst has a large specific surface area, a large pore volume, a high catalytic activity and a high sulfur recovery rate, and wherein the catalyst can support the large scale desulfurization and decontamination plants for petroleum processing, chemical processing of coal and natural gas.

The sulfur recovery catalyst according to present invention is an alumina-based catalyst having excellent specific surface area, pore volume and macroporous volume.

The alumina-based sulfur recovery catalyst according to present invention has a specific surface area of at least about 350 m²/g.

The alumina-based sulfur recovery catalyst according to present invention has a pore volume of at least about 0.40 ml/g.

In the context of present invention, the specific surface area and pore volume is determined through nitrogen adsorption method according to GB/T6609.35-2009.

According to present invention, the pore volume of pores having a pore diameter of at least about 75 nm (herein after macroporous volume) in the alumina-based sulfur recovery catalyst of present invention comprises at least about 30% of the pore volume, and/or the pore volume of pores having a pore diameter of a eas about 75 nm is at least about 0.12 ml/g.

In the context of present invention, the macroporous volume is determined by using a mercury porosimeter.

The alumina-based sulfur recovery catalyst according to present invention is made from flash calcined alumina, pseudoboehmite, and optionally, a binder. According to an advantageous aspect of present invention, the alumina-based sulfur recovery catalyst according to present invention is made from flash calcined alumina, pseudoboehmite, and a binder.

According to present invention, the flash calcined alumina used in present invention has a specific surface area of at least about 250 m²/g, preferably at least about 300 m²/g. According to present invention, the flash calcined alumina used in present invention has a pore volume of at least about 0.20 ml/g, preferably at least about 0.30 ml/g, more preferably at least about 0.35 ml/g. Generally the content of said flash calcined alumina, calculated as Al₂O₃ by weight, is at least about 90 Generally, flash calcined alumina is obtained by treating aluminium trihydrate at a certain temperature, for example at temperatures between 800-1000° C., for very short periods of time, as described in U.S. Pat. Nos. 4,051,072 and 3,222,129. It is believed that the flash calcined alumina used in present invention provides the basis of physical structure for catalysts having a large specific surface area, a large pore volume, and a high catalytic activity.

According to present invention, the pseudoboehmite used in present invention has a specific surface area of at least about 360 m²/g, preferably at least about 400 m²/g, more preferably at least about 420 m²/g. According to present invention, the pseudoboehmite used in present invention has a pore volume of at least about 0.70 ml/g, preferably at least about 1.00 ml/g, more preferably at least about 1.20 ml/g. Generally the content of said pseudoboehmite, calculated as Al₂O₃ by weight, is at least about 70%. It is believed that the pseudoboehmite used in present invention brings a good synergistic effect for further increasing the specific surface area and pore volume of the catalyst, and thus has an important influence to the increasing of catalytic activity and improvement of sulfur recovery rate.

In the context of present invention, the content of alumina is determined by a back titration method, wherein an excess amount of EDTA is used as the complexing agent and the residual EDTA is titrated by a ZnCl₂ standard solution so as to calculate the content of alumina.

If a binder is used to prepare the catalyst of present invention, binders already known in the art can be used. Preferably, the binder used is selected from the group consisting of acetic acid, nitric acid, citric acid, aluminum sol and a combination thereof, more preferably acetic acid is used as the binder. It is believed that there is a good compatibility between said binders and other ingredients of the catalyst and thus the desirable strength and stability of the catalyst according to present inventions are guaranteed.

When preparing the alumina-based sulfur recovery catalyst according to present invention, said pseudoboehmite is used in an amount of from about 5 to about 100 parts by weight (calculated as Al₂O₃), preferably from about 10 to about 60 parts by weight, based on 100 parts by weight (calculated as Al₂O₃) of the flash calcined alumina.

When preparing the alumina-based sulfur recovery catalyst according to present invention, if the binder is used, said binder is used in an amount of from about 3 to about 16 parts by weight, preferably from about 6 to about 12 parts by weight, based on 100 parts by weight (calculated as Al₂O₃) of the flash calcined alumina.

There are no particular limits to the shapes of the alumina-based sulfur recovery catalyst according to present invention, and the conventional shapes in the art can be used, including, but not limited to, spherical(balls), cylindrical, ring shape, bar shape, trefoil and the like. According to an advantageous aspect of present invention, the alumina-based sulfur recovery catalyst according to present invention is in the form of spherical particles (balls). Preferably, the spherical particles have a diameter of from about 4 mm to about 6 mm.

When the alumina-based sulfur recovery catalyst according to present invention is in the form of spherical particles, the catalyst has a crush strength of at least about 130N/particle, preferably at least about 140N/particle. The crush strength is determined according to GB/T3635.

As described above, the alumina-based sulfur recovery catalyst according to present invention is an alumina catalyst. Regarding “alumina catalyst”, it means the catalyst is free of or substantially free of solid substances other than alumina (i.e. non-alumina solid impurities). “Substantially free of” means the catalyst does not contain intentionally added solid substances other than alumina, but may contain solid substances other than alumina (impurities) introduced through the raw materials for this catalyst. According to an advantageous aspect of present invention, if present, the non-alumina solid impurities (i.e. solid substances other than alumina) is present in an amount of not more than about 0.35% by weight, preferably not more than about 0.30% by weight, based on the weight of the alumina-based sulfur recovery catalyst. In the context of present invention, the content of said non-alumina solid impurities is determined through a fluorescence analyzer. Before the determination, the catalyst is dried at a temperature of 150° C. for 2 to 3 hours. In the context of present invention, said solid substances other than alumina, include, but not limited to, sodium oxide, silica, iron oxide, etc.

Accordingly, the raw materials for preparing the alumina-based sulfur recovery catalyst according to present invention, for example flash calcined alumina, pseudoboehmite and the binder, are free of or substantially free of impurities other than aluminium. Of course, as those skilled in the art will appreciate, the raw materials may contain impurities other than aluminium which are introduced unavoidably during the preparation of these raw materials, provided the final alumina-based sulfur recovery catalyst according to present invention is free of or substantially free of solid substances other than alumina.

According to an embodiment of present invention, a high activity alumina-based sulfur recovery catalyst is provided, characterized in that this catalyst is prepared by 100 parts by weight of flash calcined alumina (calculated as Al₂O₃), about 5 to about 100 parts by weight of pseudoboehmite (calculated as Al₂O₃), and about 3 to about 16 parts by weight of a binder, wherein

a. the flash calcined alumina has a specific surface area of at least about 250 m²/g, and a pore volume of at least about 0.20 ml/g;

b. the pseudoboehmite has a specific surface area of at least about 360 m²/g, and a pore volume of at least about 0.70 ml/g;

c. the binder is any one of acetic acid, nitric acid, citric acid, aluminum sol and a combination thereof;

d. said high activity alumina-based sulfur recovery catalyst has a specific surface area of at least about 350 m²/g, a pore volume of at least about 0.40 ml/g, and a macroporous volume (the pore volume of pores having a pore diameter of at least 75 nm) comprising at least about 30% of the pore volume.

According to another embodiment of present invention, a high activity alumina-based sulfur recovery catalyst is provided, characterized in that this catalyst is prepared by 100 parts by weight of flash calcined alumina (calculated as Al₂O₃), about 10 to about 60 parts by weight of pseudoboehmite (calculated as Al₂O₃), and about 6 to about 12 parts by weight of a binder, wherein

a. the flash calcined alumina has a content of at least about 90% (calculated as Al₂O₃), a specific surface area of at least about 300 m²/g, and a pore volume of at least about 0.30 ml/g;

b. the pseudoboehmite has a content of at least about 70 wt % (calculated as Al₂O₃), a specific surface area of at east about 400 m²/g, and a pore volume of at least about 1.00 ml/g;

c. the binder is acetic acid;

said high activity alumina-based sulfur recovery catalyst has a specific surface area of at least about 350 m²/g, a pore volume of at least about 0.40 ml/g, and a macroporous volume (the pore volume of pores having a pore diameter of at least 75 nm) comprising at least about 30% of the pore volume.

According to yet another embodiment of present invention, a high activity alumina-based sulfur recovery catalyst is provided, characterized in that this catalyst is prepared by 100 parts by weight of flash calcined alumina (calculated as Al₂O₃), about 10 to about 60 parts by weight of pseudoboehmite, and about 6 to about 12 parts by weight of a binder, wherein

a. the flash calcined alumina has a content of at least about 90 wt % (calculated as Al₂O₃), a specific surface area of at east about 300 m²/g, and a pore volume of at least about 0.35 ml/g;

b. the pseudoboehmite has a content of at least about 70 wt % (calculated as Al₂O₃), a specific surface area of at least about 420 m²/g, and a pore volume of at least about 1.20 ml/g;

c. the binder is acetic acid;

said high activity alumina-based sulfur recovery catalyst has a specific surface area of at least about 350 m²/g, a pore volume of at least about 0.40 ml/g, and a macroporous volume (the pore volume of pores having a pore diameter of at least 75 nm) comprises at least about 30% of the pore volume.

The present invention further relates to a method for recovering sulfur, including applying the sulfur recovery catalyst according to present invention in a sulfur recovery unit of a sulfur recovery plant. According to an advantageous aspect of present invention, said sulfur recovery plant can be, for example, a sulfur recovery plant in industries of petroleum processing, chemical processing of coal, and natural gas. For example, the catalyst according to present invention is used to catalyze the low temperature Claus reaction between H₂S and SO₂:

2H₂S+SO₂→3/x Sx+2H₂O

The present invention further relates to a method for preparing the alumina-based sulfur recovery catalyst according to present invention. According to an aspect of present invention, the method according to present invention for preparing the catalyst includes the steps of mixing flash calcined alumina and pseudoboehmite, forming (shaping) the resulting mixture, aging, drying and calcining.

There are no particular limits to the mixing step, provided the flash calcined alumina and pseudoboehmite are mixed so as to provide a uniform mixture. Said flash calcined alumina and pseudoboehmite can be those described hereinbefore.

In the method of present invention, the pseudoboehmite can be dehydrated through drying before mixing. Preferably, the pseudoboehmite is dehydrated at a temperature of from about 500 to about 600° C. for about 1 to 4 hours, preferably for about 1 to about 2 hours.

In the method of present invention, a binder, for example, binders described hereinbefore, can be used in the forming (shaping) step. Preferably, the binder is used in the form of an aqueous solution, which is known to those skilled in the art. There are no particular limits to the forming step, and various forming processes known in the art can be used to provide the desirable shapes for the catalyst. According to an advantageous aspect of present invention, the forming step in the method of present invention is a ball forming step. For example, a ball forming machine known in the art can be used to carry out such a forming step. When formed (shaped), the resulting product can be screened to select the products with the desired size. For example, according to an embodiment of present invention, spherical particles having a diameter of from about 4 mm to about 6 mm can be selected. It is believed that spherical particles can facilitate the packing of the catalyst.

In the method of present invention, the formed catalyst obtained from the forming step can be aged. Aging operation is well known in the art. However, according to an advantageous aspect of present invention, the aging can be conducted with a water vapor having a temperature of from about 40 to about 100° C., preferably from about 80 to about 100° C., more preferably from about 90 to about 100° C. The aging can be carried out for from about 10 to about 40 hours.

The aged catalyst can be dried. The drying can be conducted at a temperature of from about 100 to about 160° C., preferably from about 110 to about 130° C. The drying can last for from about 2 to about 10 hours, preferably from about 3 to about 5 hours.

When dried, the catalyst of present invention can be calcined. According to an aspect of present invention, the dried catalyst of present invention can be calcined at a temperature of from about 350 to about 500° C., preferably from about 380 to about 450° C. for about 2 to about 10 hours, preferably from about 3 to about 5 hours.

Without to be limited by any theories, it is believed that the application of a water vapor atmosphere in the aging step can provide a catalyst having a large specific surface area, a large pore volume and an appropriate strength.

For example, a flow chart according to an embodiment of the method of present invention is illustrated in FIG. 1.

According to an embodiment of present invention, a method according to present invention for preparing a high activity sulfur recovery catalyst is provided, including the steps of:

\hat{1} Dehydrating Pseudoboehmite

dehydrating raw material pseudoboehmite at a temperature of from about 500 to about 600° C. for about 1 to about 2 hours;

\hat{2} Mixing

mixing uniformly 100 parts by weight of raw material flash calcined alumina (calculated as Al₂O₃) and from about 5 to about 100 parts by weight of the dehydrated pseudoboehmite from step \hat{1} (calculated as Al₂O₃);

\hat{3} Preparing a Binder Solution

mixing about 3 to about 16 parts by weight of a binder with water and stirred uniformly;

\hat{4} Ball Forming

adding a portion of the uniformly mixed mixture obtained from step \hat{2} into a ball forming machine, turning on the machine, and spraying the binder solution prepared in step \hat{3} onto the material in the machine; ball forming said material into small spherical particles under the action of the binder solution; keeping adding the mixture while spraying the binder solution until most of the mixture transforming into spherical particles having a diameter φ of about 4 mm to about 6 mm and stopping rotation; screening the spherical particles to collect pellets having a diameter φ of about 4 mm to about 6 mm;

\hat{5} Aging

aging the pellets having a diameter φ of about 4 mm to about 6 mm formed in step \hat{4} in water vapor atmosphere having a temperature of about 40 to about 100° C. for about 10 to about 40 hours; \hat{6} Drying

drying the aged pellets having a diameter φ of about 4 mm to about 6 mm obtained in step \hat{5} at a temperature of from about 100 to about 160° C. for about 2 to about 10 hours; and

\hat{7} Calcining

calcined the dried pellets having a diameter φ of about 4 mm to about 6 mm obtained in step \hat{6} at a temperature of from about 300 to about 500° C. for about 2 to about 10 hours so as to provide the catalyst.

According to another embodiment of present invention, in above method, the aging of step \hat{5} is conducted at a temperature of about 80 to about 100° C. for about 10 to about 40 hours, the drying of step \hat{6} is conducted at a temperature of from about 110 to about 130° C. for about 3 to about 5 hours, and the calcining of step \hat{7} is conducted at a temperature of from about 380 to about 450° C. for about 3 to about 5 hours.

According to yet another embodiment of present invention, in above method, the aging of step \hat{5} is conducted at a temperature of about 90 to about 100° C. for about 10 to about 40 hours, the drying of step \hat{6} is conducted at a temperature of from about 110 to about 130° C. for about 3 to about 5 hours, and the calcining of step \hat{7} is conducted at a temperature of from about 380 to about 450° C. for about 3 to about 5 hours.

The present invention also relates to an use of the alumina-based sulfur recovery catalyst according to present invention. The alumina-based sulfur recovery catalyst according to present invention can be used to recover sulfur from sulfur recovery plants. According to an advantageous aspect of present invention, the sulfur recovery catalyst according to present invention can be used in the catalytic reaction process for recovering element sulfur from sulfur-containing compound(s) produced from the desulfurization and decontamination plant of petroleum processing, chemical processing of coal, or natural gas.

As described above, the sulfur recovery catalyst according to present invention is a pure alumina-based catalyst and the catalyst is free of or substantially free of impurities. The pseudoboehmite used in present invention is a non-modified one, for example not modified by silicon. Thus the pseudoboehmite used in present invention does not comprise silicon, which is different from the silicon-containing pseudoboehmite used in China Patent Application 200510042213.1. Further, it should be noted that the China Patent Application 200510042213.1 relates merely to a Claus tail gas hydrogenation catalyst for reducing sulfur compound(s) other than H₂S to H₂S and thus this catalyst is a hydrogenation catalyst used in the tail gas treatment unit of a sulfur recovery plant. In contrast to China Patent Application 200510042213.1, the catalyst according to present invention is a sulfur-producing catalyst for converting a mixed gas of sulfur compounds into element sulfur, and is used in the sulfur recovery unit of a sulfur recovery plant. These two catalysts are of different types and have different purposes, though both are used in the sulfur recovery plant.

The high activity sulfur recovery catalyst, its preparing method and use according to present invention, compared with those known in the prior art, provide the following advantageous technical effects.

1. A high activity sulfur recovery catalyst which has a large specific surface area, a large pore volume, and a high catalytic activity and which can support the desulfurization and decontamination plants for petroleum processing, chemical processing of coal and natural gas as well as a preparation method and use for the same are provided;

2. The catalyst of present invention has a specific surface area of at least about 350 m²/g, a pore volume of at least about 0.40 ml/g, and a macroporous volume comprising at least about 30% of the pore volume, enabling a high Claus activity and a high organo-sulfur hydrolysis activity;

3. The crush strength of the catalyst of present invention can be higher than 160N/particle; and

4. When used in a sulfur recovery plant, the catalyst of present invention can improve the sulfur recovery rate under same operating conditions; under certain conditions, the sulfur conversion rate of the plant can be improved by from 0.5 to 1.0 percent (at least 96%), providing a notable economic and social benefit.

The present invention particularly includes the following specific embodiments:

Item 1. An alumina-based sulfur recovery catalyst, characterized in that the catalyst has a specific surface area of at least about 350 m²/g, a pore volume of at least about 0.40 ml/g, and the pore volume of pores having a pore diameter of at least 75 nm comprises at least about 30% of the pore volume.

Item 2. The alumina-based catalyst according to item 1, characterized in that the catalyst is free of or substantially free of non-alumina solid materials, preferably, if present, the non-alumina solid materials are not more than about 0.30% by weight of the alumina-based catalyst.

Item 3. The alumina-based catalyst according to item 1 or 2, characterized in that the alumina-based catalyst is made from ash calcined alumina and pseudoboehmite.

Item 4. The alumina-based catalyst according to item 3, characterized in that the alumina-based catalyst is made from flash calcined alumina, pseudoboehmite and a binder.

Item 5. The alumina-based catalyst according to item 4, characterized in that the binder is selected from the group consisting of acetic acid, nitric acid, citric acid, aluminum sol and a combination thereof, preferably the binder is acetic acid.

Item 6. The alumina-based catalyst according to any one of items 3-5, characterized in that the pseudoboehmite is used in an amount of from about 5 to about 100 parts by weight (calculated as Al₂O₃), preferably from about 10 to about 60 parts by weight, based on 100 parts by weight of the flash calcined alumina (calculated as Al₂O₃).

Item 7. The alumina-based catalyst according to any one of items 3-6, characterized in that the binder is used in an amount of from about 3 to about 16 parts by weight, preferably from about 6 to about 12 parts by weight, based on 100 parts by weight of the flash calcined alumina (calculated as Al₂O₃).

Item 8. The alumina-based catalyst according to any one of items 3-7, characterized in that the flash calcined alumina has a specific surface area of at least about 250 m²/g, preferably at least about 300 m²/g, and a pore volume of at least about 0.20 ml/g, preferably at least about 0.30 ml/g, and more preferably at least about 0.35 ml/g.

Item 9. The alumina-based catalyst according to any one of items 3-8, characterized in that the pseudoboehmite has a specific surface area of at least about 360 m²/g, preferably at least about 400 m²/g, more preferably at least about 420 m²/g, and a pore volume of at east about 0.70 ml/g, preferably at least about 1.00 ml/g, and more preferably at least about 1.20 ml/g.

Item 10. The alumina-based catalyst according to any one of items 3-9, characterized in that the content of the flash calcined alumina, calculated as Al₂O₃, is at least about 90 wt %.

Item 11. The alumina-based catalyst according to any one of items 3-10, characterized in that the content of the pseudoboehmite, calculated as Al₂O₃, is at least about 70 wt %.

Item 12. The alumina-based catalyst according to any one of items 11, characterized in that the catalyst is in the form of spherical particles, preferably spherical particles having a diameter of from about 4 mm to about 6 mm.

Item 13. The alumina-based catalyst according to item 12, characterized in that the catalyst has a crush strength of at east about 130N/particle, preferably at least about 140N/particle.

Item 14. A method for preparing the alumina-based sulfur recovery catalyst according to item 1, characterized in that the method includes the steps of mixing flash calcined alumina and pseudoboehmite, forming the resulting mixture, aging, drying and calcining.

Item 15. The method according to item 14, wherein the pseudoboehmite is dehydrated before the mixing, preferably the pseudoboehmite is dehydrated at a temperature of from about 500° C. to about 600° C. for about 1 to about 4 hours, preferably for about 1 to about 2 hours before the mixing.

Item 16. The method according to any one of items 14-15, wherein a binder is used in the forming step, preferably the binder is used in the form of an aqueous solution.

Item 17. The method according to any one of items 14-16, wherein the forming is ball forming.

Item 18. The method according to any one of items 14-17, wherein the aging is conducted for about 10 to about 40 hours by using a water vapor of a temperature of from about 40 to about 100° C., preferably from about 80 to about 100° C., and more preferably from about 90 to about 100° C.

Item 19. The method according to any one of items 14-18, wherein the drying is conducted at a temperature of from about 100 to about 160° C., preferably from about 110 to about 130° C., for about 2 to about 10 hours, preferably about 3 to about 5 hours.

Item 20. The method according to any one of items 14-19, wherein the calcining is conducted at a temperature of from about 300 to about 500° C., preferably from about 350 to about 500° C., more preferably from about 380 to about 450° C. for about 2 to about 10 hours, preferably about 3 to about 5 hours.

Item 21. A method for preparing the alumina-based catalyst according to item 1, characterized in that the method includes the steps of

dehydrating pseudoboehmite at a temperature of from about 500 to about 600° C. for about 1 to about 2 hours;

mixing uniformly 100 parts by weight of flash calcined alumina (calculated as Al₂O₃) and from about 5 to about 100 parts by weight of the dehydrated pseudoboehmite (calculated as Al₂O₃);

preparing a binder aqueous solution from about 3 to about 16 parts by weight of a binder and water;

ball forming the mixture of flash calcined alumina and the dehydrated pseudoboehmite by using the binder aqueous solution to provide pellets;

aging the formed pellets in water vapor atmosphere having a temperature of about 40 to about 100° C. for about 10 to about 40 hours;

drying the aged pellets at a temperature of from about 100 to about 160° C. for about 2 to about 10 hours; and

calcined the dried pellets at a temperature of from about 350 to about 500° C. for about 2 to about 10 hours.

Item 22. A method for recovering sulfur including applying the catalyst according to any one of items 1-13 in a sulfur recovery unit of a sulfur recovery plant.

Item 23. Use of the alumina-based sulfur recovery catalyst according to any one of items 1-13 in the catalytic reaction process for recovering sulfur from sulfur-containing compound(s) produced from the desulfurization and decontamination plant of natural gas, petroleum processing, or chemical processing of coal.

### BRIEF DESCRIPTION OF THE DRAWINGS

FIG. 1 shows a flow chart for preparing the sulfur recovery catalyst according to an embodiment of present invention.

FIG. 2 illustrates the apparatus for evaluating the activity of the sulfur recovery catalyst of present invention.

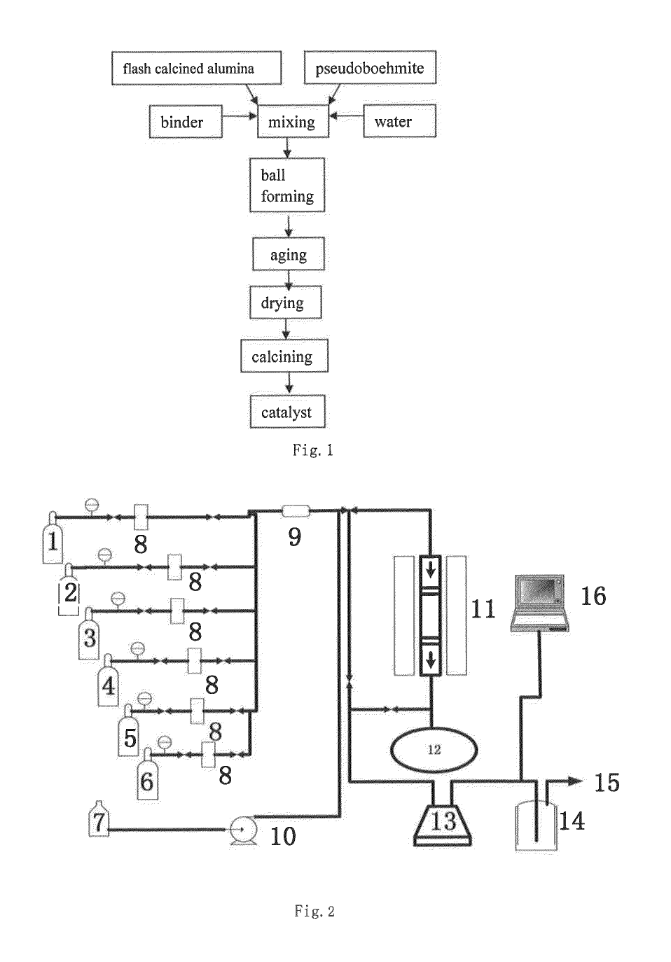

In FIG. 2,

1—H₂ cylinder, 2—O₂ cylinder, 3—H₂S cylinder, 4—SO₂ cylinder, 5—N₂ cylinder, 6—CS₂ cylinder, 7—water container, 8—mass flowmeter, 9—buffer tank, 10—water pump, 11—reactor, 12—condenser, 13—cold trap, 14—alkali washing tank, 15—tail gas venting, 16—chromatograph

### EMBODIMENTS FOR CARRYING OUT PRESENT INVENTION

The present invention will be further described with reference to examples.

In examples 1-14 and comparative examples 1-2, the flash calcined alumina used has a content by weight (calculated as Al₂O₃) of 90%, and the pseudoboehmite used has a content by weight (calculated as Al₂O₃) of 70%; both are commercial available.

### Example 1

1 Kg pseudoboehmite having a specific surface area of 426 m²/g and a pore volume of 1.22 ml/g was put into a calcining oven and was dehydrated at 550° C. for 2 hours. 3.5 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 371 m²/g, a pore volume of 0.46 ml/g, a macroporous volume of 0.17 ml/g and a crush strength of 160N/particle.

### Example 2

1.2 Kg pseudoboehmite having a specific surface area of 426 m²/g and a pore volume of 1.22 ml/g was put into a calcining oven and was dehydrated at 550° C. for 2 hours. 3.3 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 375 m²/g, a pore volume of 0.47 ml/g, a macroporous volume of 0.17 ml/g and a crush strength of 151N/particle.

### Example 3

0.5 Kg pseudoboehmite having a specific surface area of 426 m²/g and a pore volume of 1.22 ml/g was put into a calcining oven and was dehydrated at 550° C. for 2 hours. 4 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 352 m²/g, a pore volume of 0.42 ml/g, a macroporous volume of 0.15 ml/g and a crush strength of 166N/particle.

### Example 4

1 Kg pseudoboehmite having a specific surface area of 426 m²/g and a pore volume of 1.22 ml/g was put into a calcining oven and was dehydrated at 550° C. for 2 hours. 3.5 Kg flash calcined alumina having a specific surface area of 325 m²/g and a pore volume of 0.42 ml/g was mixed uniformly with the dehydrated pseudoboehmite.

273 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 373 m²/g, a pore volume of 0.46 ml/g, a macroporous volume of 0.16 ml/g and a crush strength of 145N/particle.

### Example 5

1 Kg pseudoboehmite having a specific surface area of 426 m²/g and a pore volume of 1.22 ml/g was put into a calcining oven and was dehydrated at 550° C. for 2 hours. 3.5 Kg flash calcined alumina having a specific surface area of 325 m²/g and a pore volume of 0.42 ml/g was mixed uniformly with the dehydrated pseudoboehmite.

497 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 361 m²/g, a pore volume of 0.44 ml/g, a macroporous volume of 0.16 ml/g and a crush strength of 152N/particle.

### Example 6

1 Kg pseudoboehmite having a specific surface area of 426 m²/g and a pore volume of 1.22 ml/g was put into a calcining oven and was dehydrated at 550° C. for 2 hours. 3.5 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 12 hours, dried at 120° C. for 4 hours, and calcined at 400° C. for 3 hours to obtain the finished catalyst. The catalyst had a specific surface area of 356 m²/g, a pore volume of 0.44 ml/g, a macroporous volume of 0.16 ml/g and a crush strength of 143N/particle.

### Example 7

1.6 Kg pseudoboehmite having a specific surface area of 426 m²/g and a pore volume of 1.22 ml/g was put into a calcining oven and was dehydrated at 550° C. for 2 hours. 2.9 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 385 m²/g, a pore volume of 0.48 ml/g, a macroporous volume of 0.17 ml/g and a crush strength of 144N/particle.

### Example 8

1 Kg pseudoboehmite having a specific surface area of 403 m²/g and a pore volume of 1.06 ml/g was put into a calcining oven and was dehydrated at 550° C. for 2 hours. 3.5 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 364 m²/g, a pore volume of 0.44 ml/g, a macroporous volume of 0.15 ml/g and a crush strength of 161N/particle.

### Example 9

1 Kg pseudoboehmite having a specific surface area of 435 m²/g and a pore volume of 1.30 ml/g was put into a calcining oven and was dehydrated at 550° C. for 2 hours. 3.5 Kg flash calcined alumina having a specific surface area of 325 m²/g and a pore volume of 0.42 ml/g was mixed uniformly with the dehydrated pseudoboehmite.

362 g acetic acid having a purity of 99 as dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 380 m²/g, a pore volume of 0.47 ml/g, a macroporous volume of 0.17 ml/g and a crush strength of 149N/particle.

### Example 10

1 Kg pseudoboehmite having a specific surface area of 426 m²/g and a pore volume of 1.22 ml/g was put into a calcining oven and was dehydrated at 550° C. for 2 hours. 3.5 Kg flash calcined alumina having a specific surface area of 325 m²/g and a pore volume of 0.42 g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 480° C. for 3 hours to obtain the finished catalyst. The catalyst had a specific surface area of 352 m²/g, a pore volume of 0.48 ml/g, a macroporous volume of 0.17 ml/g and a crush strength of 152N/particle.

### Example 11

1 Kg pseudoboehmite having a specific surface area of 426 m²/g and a pore volume of 1.22 ml/g was put into a calcining oven and was dehydrated at 550° C. for 2 hours. 3.5 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 360° C. for 3 hours to obtain the finished catalyst. The catalyst had a specific surface area of 378 g, a pore volume of 0.43 ml/g, a macroporous volume of 0.15 ml/g and a crush strength of 155N/particle.

### Example 12

1 Kg pseudoboehmite having a specific surface area of 426 m²/g and a pore volume of 1.22 ml/g was put into a calcining oven and was dehydrated at 550° C. for 2 hours, 3.5 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 40 hours, dried at 120° C. for 4 hours, and calcined at 400° C. for 3 hours to obtain the finished catalyst. The catalyst had a specific surface area of 362 m²/g, a pore volume of 0.45 ml/g, a macroporous volume of 0.16 ml/g and a crush strength of 165N/particle.

### Example 13

1 Kg pseudoboehmite having a specific surface area of 426 m²/g and a pore volume of 1.22 ml/g was put into a calcining oven and was dehydrated at 550° C. for 2 hours. 3.5 Kg flash calcined alumina having a specific surface area of 325 m²/g and a pore volume of 0.42 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 80° C. for 30 hours, dried at 120° C. for 4 hours, and calcined at 400° C. for 3 hours to obtain the finished catalyst. The catalyst had a specific surface area of 354 m²/g, a pore volume of 0.44 ml/g, a macroporous volume of 0.15 ml/g and a crush strength of 151N/particle.

### Example 14

1 Kg pseudoboehmite having a specific surface area of 426 m²/g and a pore volume of 1.22 ml/g was put into a calcining oven and was dehydrated at 550° C. for 2 hours. 3.5 Kg flash calcined alumina having a specific surface area of 302 m²/g and a pore volume of 0.36 ml/g was mixed uniformly with the dehydrated pseudoboehmite.

362 g acetic acid having a purity of 99.5 wt % was dissolved into water and stirred uniformly to provide a binder solution. The mixed solid material was transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst. The catalyst had a specific surface area of 354 m²/g, a pore volume of 0.41 ml/g, a macroporous volume of 0.14 ml/g and a crush strength of 167N/particle.

### Comparative 1

4.5 Kg flash calcined alumina having a specific surface area of 325 m²/g and a pore volume of 0.42 ml/g was used as the raw material for the catalyst. 362 g acetic acid having a purity of 99.5 wt % was dissolved into water and stirred uniformly to provide a binder solution. The solid material was transferred into a ball forming machine and the prepared binder solution was sprayed slowly onto the solid material while rotating the machine so as to provide catalyst pellets having a diameter 9 of 4-6 mm. The pellets was aged in water vapor atmosphere having a temperature of 100° C. for 30 hours, dried at 120° C. for 4 hours, and calcined at 400° C. for 3 hours to obtain the finished catalyst product. The catalyst had a specific surface area of 315 m²/g, a pore volume of 0.41 ml/g, a macroporous volume of 0.10 ml/g and a crush strength of 166N/particle.

### Comparative 2

4.5 Kg flash calcined alumina having a specific surface area of 302 m²/g and a pore volume of 0.39 ml/g was used as the raw material for the catalyst. 362 g acetic acid having a purity of 99.5 wt % was dissolved into water and stirred uniformly to provide a binder solution. The solid material as transferred into a ball forming machine and the prepared binder solution was sprayed slowly onto the solid material while rotating the machine so as to provide catalyst pellets having a diameter φ of 4-6 mm. The pellets was aged in water vapor atmosphere having a temperature of 100° C. for 30 hours, dried at 120° C. for 4 hours, and calcined at 400° C. for 3 hours to obtain the finished catalyst product. The catalyst had a specific surface area of 288 m²/g, a pore volume of 0.37 ml/g, a macroporous volume of 0.09 ml/g and a crush strength of 170N/particle.

The test for evaluating the activity of the sulfur recovery catalysts prepared in examples 1-14 and comparative examples 1-2 was carried out as follows:

The activity evaluating test for the sulfur recovery catalyst was conducted on a 10 ml sulfur micro-reactor apparatus. The reactor was made from a stainless steel pipe having an internal diameter of 20 mm and the reactor was placed in a thermotank; see FIG. 2. The packing amount of catalyst was 10 ml, and quartz sand having an identical particle size was packed at the top part for preheating. The contents of H₂S, SO₂, COS and CS₂ in the gas at the inlet and outlet of the reactor were determined online by the gas chromatography GC-2014 of SHIMADZU, Japan, wherein sulfur compounds were analyzed by using GDX-301 support, and O₂ content was analyzed by using 5A molecular sieve, column temperature 120° C., thermal conductivity detector, carrier gas H₂, and flow rate 25 ml/min.

The Claus activity of the catalyst was evaluated on the basis of the reaction 2H₂S+SO₂→3/x Sₓ+2H₂O. The composition of gas at inlet was, by volume, H₂S 2%, SO₂ 1%, O₂ 3000 ppm, H₂O 30%, N₂ balance. The volume space velocity was 2500 h⁻¹ and the temperature for reaction was 230° C. The Claus conversion rate was calculated according the equation below:

$${η}_{H 2 S + S O 2} = \frac{{M}_{0} - {M}_{1}}{{M}_{0}} \times 100 \%$$

wherein M₀ representing the sum of concentrations of H₂S and SO₂ (by volume) at inlet, and M₁ representing the sum of concentrations of H₂S and SO₂ (by volume) at outlet. The sampling and analysis were conducted every hour and the result was an average over 10 hours.

The organo-sulfur hydrolysis activity of the catalyst was evaluated on the basis of the reaction CS₂+2H₂O→CO₂+2H₂S. The composition of gas at inlet was, by volume, H₂S 2%, CS₂ 0.6%, SO₂ 1%, O₂ 3000 ppm, H₂O 30%, N₂ balance. The volume space velocity was 2500 h⁻¹ and the temperature for reaction was 280° C. The hydrolysis rate of CS₂ was calculated according the equation below:

$${η}_{C S 2} = \frac{{C}_{0} - {C}_{1}}{{C}_{0}} \times 100 \%$$

wherein C₀ and C₁ representing respectively concentrations of CS₂ (by volume) at inlet and outlet. The sampling and analysis were conducted every hour and the result was an average over 10 hours.

The activities of the catalysts prepared in examples 1-14 and comparative examples 1-2 were evaluated according above tests and the results were summarized in table 1 below.

The solid substances other than alumina in the catalysts prepared in examples 1-14 and comparative examples 1-2 were determined by using a fluorescence analyzer. These catalysts all had not more than 0.30% by weight of solid substances other than alumina,

TABLE 1
Activities of Catalyst

| Catalyst | Claus Activity, % | Hydrolysis Activity, % |
|---|---|---|
| Example 1 | 82 | 94 |
| Example 2 | 82 | 94 |
| Example 3 | 81 | 93 |
| Example 4 | 82 | 94 |
| Example 5 | 81 | 94 |
| Example 6 | 81 | 93 |
| Example 7 | 82 | 95 |
| Example 8 | 81 | 94 |
| Example 9 | 82 | 95 |
| Example 10 | 81 | 93 |
| Example 11 | 81 | 93 |
| Example 12 | 81 | 93 |
| Example 13 | 81 | 93 |
| Example 14 | 81 | 93 |
| Comparative Example 1 | 79 | 91 |
| Comparative Example 2 | 78 | 90 |

What is claimed is:

1. An alumina-based sulfur recovery catalyst, characterized in that the catalyst has a specific surface area of at least about 350 m²/g, a pore volume of at least about 0.40 ml/g, and the pore volume of pores having a pore diameter of at least 75 nm comprises at least about 30% of the pore volume.

2. The alumina-based catalyst according to claim 1, characterized in that the catalyst is free of or substantially free of non-alumina solid materials, preferably, if present, the non-alumina solid materials are not more than about 0.30% by weight of the alumina-based catalyst.

3. The alumina-based catalyst according to claim 1, characterized in that the alumina-based catalyst is made from flash calcined alumina, pseudoboehmite, and optionally a binder.

4. The alumina-based catalyst according to claim 3, characterized in that the binder is selected from the group consisting of acetic acid, nitric acid, citric acid, aluminum sol and a combination thereof, preferably the binder is acetic acid.

5. The alumina-based catalyst according to claim 3, characterized in that the pseudoboehmite is used in an amount of from about 5 to about 100 parts by weight (calculated as Al₂O₃), preferably from about 10 to about 60 parts by weight, and the binder, if present, is used in an amount of from about 3 to about 16 parts by weight, preferably from about 6 to about 12 parts by weight, based on 100 parts by weight of the flash calcined alumina (calculated as Al₂O₃).

6. The alumina-based catalyst according to claim 3, characterized in that the flash calcined alumina has a specific surface area of at least about 250 m²/g, preferably at least about 300 m²/g, and a pore volume of at least about 0.20 ml/g, preferably at least about 0.30 ml/g, and more preferably at least about 0.35 ml/g.

7. The alumina-based catalyst according to claim 3, characterized in that the pseudoboehmite has a specific surface area of at east about 360 m²/g, preferably at least about 400 m²/g, more preferably at least about 420 m²/g, and a pore volume of at east about 0.70 ml/g, preferably at least about 1.00 ml/g, and more preferably at least about 1.20 ml/g.

8. The alumina-based catalyst according to claim 1, characterized in that the catalyst is in the form of spherical particles, preferably spherical particles having a diameter of from about 4 mm to about 6 mm.

9. The alumina-based catalyst according to claim 8, characterized in that the catalyst has a crush strength of at least about 130N/particle, preferably at least about 140N/particle.

10. A method for preparing the alumina-based sulfur recovery catalyst according to claim 1, characterized in that the method includes the steps of mixing flash calcined alumina and pseudoboehmite, forming the resulting mixture, aging, drying and calcining.

11. The method according to claim 10, wherein the pseudoboehmite is dehydrated before the mixing, preferably the pseudoboehmite is dehydrated at a temperature of from about 500° C. to about 600° C. for about 1 to about 4 hours, preferably for about 1 to about 2 hours before the mixing.

12. The method according to claim 10, wherein a binder is used in the forming step, preferably the binder is used in the form of an aqueous solution.

13. The method according to claim 10, wherein the forming is ball forming.

14. The method according to claim 10, wherein the aging is conducted for about 10 to about 40 hours by using a water vapor of a temperature of from about 40 to about 100° C., preferably from about 80 to about 100° C., and more preferably from about 90 to about 100° C.

15. A method for recovering sulfur including applying the catalyst according to claim 1 in a sulfur recovery unit of a sulfur recovery plant.

16. Use of the alumina-based sulfur recovery catalyst according to claim 1 in the catalytic reaction process for recovering sulfur from sulfur-containing compound(s) produced from the desulfurization and decontamination plant of natural gas, petroleum processing, or chemical processing of coal.
